(19) United States
(12) Patent Application Publication
(10) Pub. No.: US 2009/0150285 A1
(43) Pub. Date: Jun. 11, 2009

(54) SYSTEM AND METHOD FOR SELLING ALTERNATIVE FUEL VEHICLES

(75) Inventor: Markus Seidel, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/953,414

(22) Filed: Dec. 10, 2007

(51) Int. Cl. G06Q 30/00

(52) U.S. Cl. 705/40

(57) ABSTRACT

An alternative fuel vehicle is provided to a consumer at an initial purchase price or lease rate which is subsidized by the vehicle manufacturer or financing institution. In one embodiment, the vehicle purchaser is then charged a periodic user fee that is a function of both the distance driven over some predetermined period of time and an applicable unit rate.

### FIELD OF THE INVENTION

The present invention relates in general to systems and methods for vehicle sales or leasing, and more particularly to systems and methods for selling alternative fuel vehicles.

### BACKGROUND OF THE INVENTION

In large part due to the climate change debate of the last few years, worldwide interest in alternative fuel (e.g., battery-driven, plug-in hybrid, etc.) vehicles has increased considerably. Carbon dioxide emissions from internal combustion engines are widely considered a key factor in global warming. In general, alternative fuel vehicles are seen as much safer on the environment due to their emission-free operation.

One significant drawback to the use of alternative fuel vehicles, including battery-driven electric vehicles or plug-in hybrid vehicles, is their higher cost as compared to vehicles having traditional internal combustion engines. Even if considerable progress in alternative fuel technologies (e.g., battery) are made, the expense of such vehicles is expected to continue to be high thereby significantly limiting their ability to penetrate the market.

On the other hand, one significant advantage of alternative fuel vehicles tends to be much lower associated fuel costs. It has been estimates that the energy-related costs for each charging operation of a battery-driven vehicle amounts to approximately $2 to $3 (based on a battery pack of 20 kilowatt per hour (kwh) with costs per kwh varying between 10 and 15 cent). Of course, the actual cost of recharging the battery will depend on local electricity prices. In comparison to classic gasoline or diesel fuels, this results in much lower operating costs.

The California Air Resources Board (CARB) is the “clean air agency” of the state of California in the United States and is the leader in the development of programs designed to reduce emissions from mobile sources. It, and many other similar environmental agencies around the world, have begun to promulgate regulations relating to the development and deployment of both low-emission vehicles and so-called zero emission vehicles. Due to the pressure from such regulations, at least in part, vehicle manufacturers have spent billions of dollars to develop and market alternative fuel vehicles. However, as will be illustrated with reference to FIG. 1 below, the higher cost of introducing such vehicles into the marketplace has significantly stunted such efforts.

FIG. 1 depicts a graph 100 of the total costs of owning and operating a vehicle as a function of the number of miles driven. In particular, plot 110 corresponds to the total costs associated with owning and operating a traditional internal combustion vehicle. As can be seen, while the purchase price 140 is relatively low, the slope of plot 110 is steep due to the relatively high fuel costs associated with driving internal combustion vehicles. The slope of plot 110 is primarily a function of fossil fuel costs. In contrast, the purchase price 150 of an alternative fuel vehicle tends to be quite high, while the attendant operating costs are very low, as illustrated by plot 120. The small slope of plot 120 is primarily associated with the costs of the alternative fuel, which is typically quite low. In the case of battery-driven vehicles or plug-in hybrids, this slope would be a function of the energy-related costs for each battery charging operation. It should further be appreciated that other costs of ownership, such as wear-and-tear, are not represented in FIG. 1 for simplicity sake. However, even if such costs were included, the basic relationship between plot 110 and plot 120 would not materially change.

Continuing to refer to FIG. 1, once the vehicles have been driven X₁ miles the total cost of owning and operating an internal combustion vehicle would roughly equal the total costs of owning and operating an alternative fuel vehicle (point 130). Before X₁ miles, the total cost of such an alternative fuel vehicle would be comparatively higher, while driving more then X₁ miles would cause the total costs associated with an alternative fuel vehicle to be lower.

The relationship depicted in FIG. 1 makes it difficult for consumers to justify purchasing alternative fuel vehicles when such consumers do not have the financial ability to cover the high purchase price 150, do not expect to drive at least X₁ miles, or simply do not know how much they will be driving and hence whether they will ever be able to recoup the initial premium paid over conventional fossil fuel vehicles. Accordingly, there is a need in the art for an improved approach to selling alternative fuel vehicles.

### BRIEF SUMMARY OF THE INVENTION

Disclosed and claimed herein systems, methods and computer program products relating to the sale of alternative fuel vehicles. In one embodiment, a method includes receiving mileage information from an alternative fuel vehicle that was provided to a consumer at a subsidized purchase price, wherein the mileage information corresponds to a distance traveled by the alternative fuel vehicle over a predetermined period of time. The method further includes calculating a user fee based on the mileage information and an applicable unit rate, and then billing the consumer the user fee.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a graph of the traditional cost relationship between a traditional combustion engine vehicle and an alternative fuel vehicle;

FIG. 2 depicts a graph of the cost relationship between the traditional approach to selling alternative fuel vehicles and one embodiment of an approach for selling alternative fuel vehicles in accordance with the principles of the invention;

FIG. 3 is a process for implementing the invention according to one embodiment; and

FIG. 4 is a system for implementing the invention according to one embodiment.

### DETAILED DESCRIPTION OF EXEMPLARY EMBODIMENTS

The present disclosure relates generally to the sale of alternative fuel vehicles at an initial purchase price which is subsidized by the vehicle manufacturer or financing institution. In one embodiment, the vehicle purchaser is charged a periodic user fee that is a function of both the distance driven over some predetermined period of time and an applicable unit rate. Other embodiments and features are described below.

It should be appreciated that the principles of the invention are applicable to vehicles based on any fuel (incl. electricity) that have better mileage-costs than regular petroleum based fuels, but higher powertrain costs due to the new technology. It should further be appreciated that, since this ratio may be influenced by governmental or state regulatory agencies, it may vary from between states and/or between countries.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention may described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

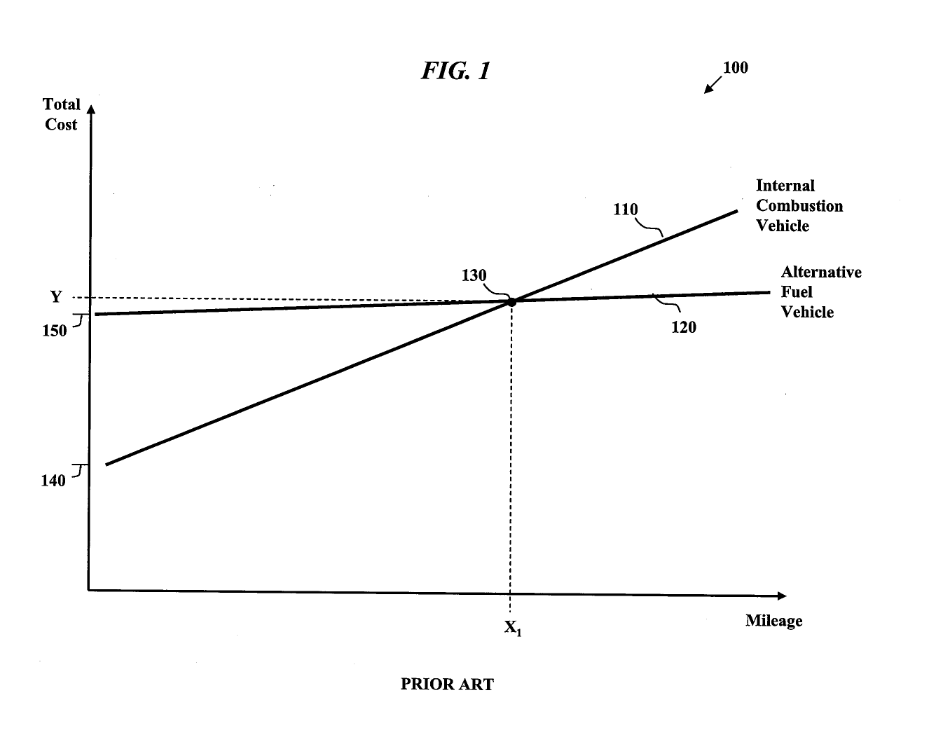

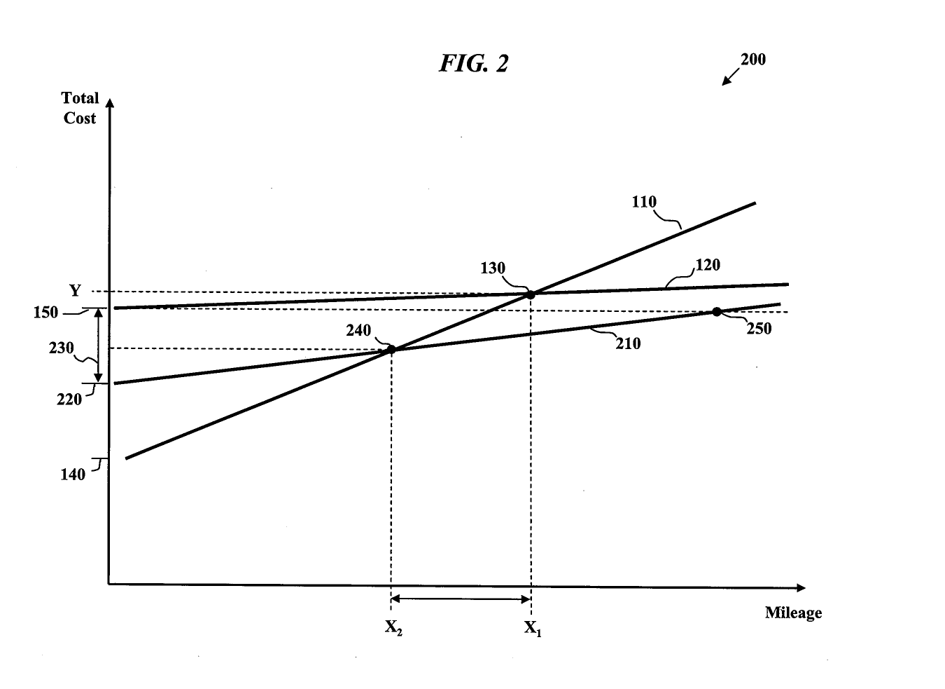

Referring now to FIG. 2, depicted is a graph 200 which includes the conventional plots 110 and 120 of FIG. 1. As described above, it is only once an alternative fuel vehicle have been driven X₁ miles that the total cost of owning and operating an internal combustion vehicle would roughly equal the total costs of owning and operating such an alternative fuel vehicle (point 130).

However, graph 200 further includes plot 210, which represents the total cost associated with owning an operating an alternative fuel vehicle which has been purchased in accordance with one embodiment of the invention. In particular, in one embodiment of the invention the initial purchase price of the alternative fuel vehicle is reduced by a discount amount 230 and offered at a subsidized purchase price 220 (or lease rate). The consumer is then also charged a periodic user fee which is based on the number of miles driven over some predetermined period of time (e.g., daily, weekly, monthly, annually, etc.). In short, some portion of the fixed purchase price equal to the discount amount 230 is converted from a fixed cost to a variable cost in the form of a consumer user fee. It should further be appreciated that other costs of ownership, such as wear-and-tear, are not represented in FIG. 2 for simplicity sake. However, even if such costs were included, the basic relationships depicted in FIG. 2 would not materially change.

As can be seen from FIG. 2, the slop of plot 210 is steeper than the slope of plot 120—the plot of the total cost of an alternative fuel vehicle purchased using the conventional approach. This is due to the fact that the slope of plot 210 is a function of both the energy-related costs for each battery charging operation, as well as the periodic user fee.

The effect of this new approach is not only to lower the initial investment for the alternative fuel vehicle, but also to move the breakeven point 240 back from X₁ miles to X₂ miles, as shown in FIG. 2. That is, a consumer has to drive a substantially less amount (i.e., X₂ miles) before being able to recoup the initial premium over conventional fossil fuel vehicles.

While it is clear that the consumer is benefited both in terms of the subsidized purchase price 220, as well as being able to earlier recover the initial purchase premium paid over conventional fossil fuel vehicles (i.e., driving X₂ miles instead X₁ miles), the net profit for the vehicle manufacturer will also need to be considered. To that end, FIG. 2 also shows how the vehicle manufacturer is able to recoup the discount amount 230 at point 250. While the manufacturer may have to wait until the requisite number of miles (e.g., corresponding to point 250) has been driven until it recovers its initial subsidy 230, the manufacturer should also be benefited by an increased volume in purchases correlated to the lower purchase price. That is, point 250 may actually occur much earlier than depicted in FIG. 2 since the marginal cost of an alternative fuel vehicle will decrease as production volume increases.

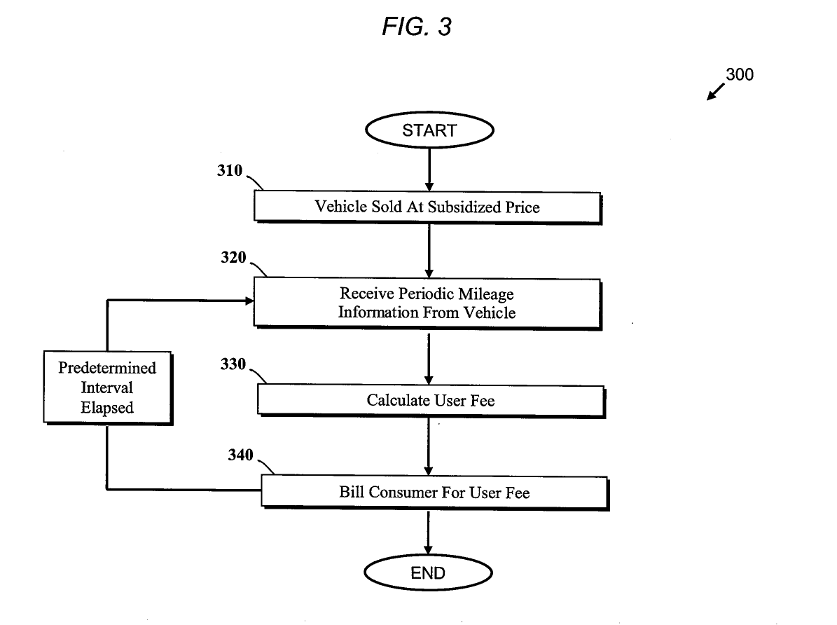

Referring now to FIG. 3, depicted is one embodiment of a process for carrying out one or more embodiments of the invention. In particular, process 300 begins at block 310 where an alternative fuel vehicle is sold at a subsidized price (e.g., subsidized purchase price 220) to a consumer. It should be appreciated that the vehicle may be sold by the manufacturer or financing institution in the case of a leased vehicle. That is, the invention is equally applicable to purchased or financed vehicles, including leased vehicles since lease payments are based on an underlying purchase amount that is used (along with the residual rate and lease term) to compute the lease payment. It should further be appreciated that the amount of the subsidy applied at block 310 may vary and depend on any combination of factors.

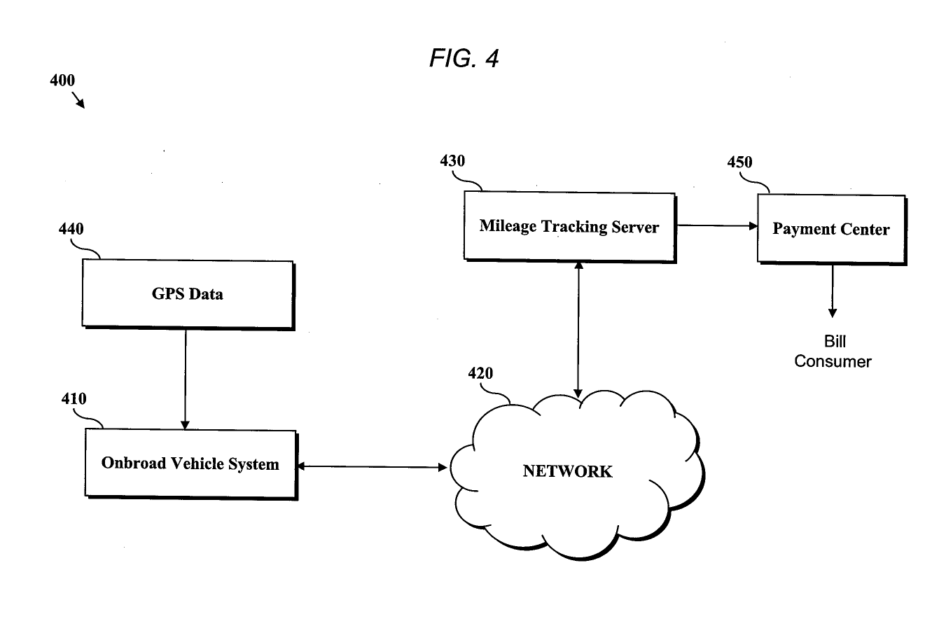

Once the vehicle is purchased or leased, process 300 may continue to block 320 where mileage information may be received from the vehicle. Such mileage information may comprise data representative of a number of miles driven, and may be provided periodically (e.g., daily, weekly, monthly, annually, etc.). As described in more detail below with reference to FIG. 4, such information may be provided by way of telematics whereby an onboard vehicle system autonomously transmits such mileage information to a remote mileage tracking server or database managed by the vehicle manufacturer, financing company or an appointed service provider. Such mileage information may be based on onboard vehicle odometer readings and/or global position system (GPS) data.

In any event, once the mileage information from block 320 has been received, process 300 may continue to block 330 where the user fee may be calculated based on at least two components—a number of miles driven and a per-mile fee or unit rate, where the number of miles driven is included in the mileage information received at block 320. The unit rate used for calculating the user fee may be based on any number of factors. In one embodiment, the applicable unit rate may be part of the vehicle owner's account information.

By way of providing a non-limiting example, suppose the mileage information from block 320 indicates that the subject vehicle has been driven 1000 miles over the predetermined period of time (e.g., one month). Suppose further that the applicable unit rate for the user fee is $0.10/mile. In this simple example, the amount of the user fee calculated at block 330 would be equal to $100, which can be found by multiplying the mileage information (i.e., 1000 miles) by the applicable unit rate (i.e., $0.10/mile). It should of course be understood that the applicable unit rate may be in terms of any monetary denomination, and that the distance driven may be denoted in any other measurement of length (e.g., kilometers).

Once the amount of the user fee has been calculated at block 330, process 300 may then continue to block 340 where the calculated fee may then be billed to the vehicle owner/operator at the predetermined interval. The operation of blocks 320-340 may then repeat once the predetermined interval elapses (e.g., monthly, annually, etc.). It should be appreciated that the mileage information may be received (block 320) more frequency (e.g., daily, weekly, etc.) than the user fee being calculated and/or billed to the consumer.

It should further be appreciated that a potential additional benefit of at least certain embodiments of the invention is that much more detailed information on consumer driving habits and preferences is available. Until now, vehicle manufacturers receive very little particularized information on driving behavior. The principles of the invention may be used to provide a more detailed picture to vehicle manufacturers of how their customers are actually using their products since periodic mileage information is received directly from the vehicle, as described above. In this fashion, vehicle manufacturers will know, not only the total number of miles driven by a particular customer, but also the exact distribution over the course of any given year.

Referring now to FIG. 4, depicted is a simplified block diagram of one embodiment of a system 400 configured to carry out one or more aspects of the invention. In particular, system 400 includes an onboard vehicle system 410 in communication with a mileage tracking server 430 via a wireless network connection 420. In one embodiment, the onboard vehicle system 410 may communicate with the server 430 using well-known telematics technology. In any event, the details of providing data communications between an onboard vehicle system (e.g., system 410) and a remote server (e.g., server 430) are known in the art and beyond the scope of this disclosure.

In one embodiment, the onboard vehicle system 410 may collect odometer information using one or more vehicle sensors (not shown) in order to determine mileage information. Alternatively, the onboard vehicle system 410 may obtain distance information in the form of GPS data 440 using an onboard GPS receiver system, which is also not shown but readily known in the art. In either case, the onboard vehicle system 410 may then generate data representative of the number of miles traveled by the vehicle and communicate this information to the mileage tracking server 430 via network 420 on demand, or on a periodic basis.

Continuing to refer to FIG. 4, the mileage tracking server 430, either alone or in combination with a payment center 450 may then calculate the user fee that is to be due based on both the received mileage information from the onboard vehicle system 410, as well as the unit rate identified in the vehicle owner's account. Once the applicable user fee has been calculated, the consumer (vehicle owner) may be billed accordingly.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method comprising the acts of:
receiving mileage information from an alternative fuel vehicle that was provided to a consumer at a subsidized purchase price, wherein the mileage information includes a distance traveled by the alternative fuel vehicle over a predetermined period of time;
calculating a user fee based on said mileage information and an applicable unit rate, wherein the applicable unit rate is based at least in part on the subsidized purchase price; and
generating a bill for the consumer corresponding to the user fee.

2. The method of claim 1, wherein the subsidized purchase price comprises a subsidized lease rate.

3. The method of claim 1, wherein said mileage information is based on at least one of global positing system data and odometer information for the alternative fuel vehicle.

4. The method of claim 1, wherein calculating the user fee comprises multiplying said distance traveled by the applicable unit rate.

5. The method of claim 1, wherein billing the consumer comprises billing the consumer the user fee on an interval based on said predetermined period of time.

6. (canceled)

7. A computer program product, comprising:
a processor readable medium having processor executable code embodied therein, the processor readable medium having:
processor executable program code to receive mileage information from an alternative fuel vehicle that was provided to a consumer at a subsidized purchase price, wherein the mileage information includes a distance traveled by the alternative fuel vehicle over a predetermined period of time;
processor executable program code to calculate a user fee based on said mileage information and an applicable unit rate, wherein the applicable unit rate is based at least in part on the subsidized purchase price; and
processor executable program code to bill the consumer the user fee.

8. The computer program product of claim 7, wherein subsidized purchase price comprises a subsidized lease rate.

9. The computer program product of claim 7, wherein said mileage information is based on at least one of global positing system data and odometer information for the alternative fuel vehicle.

10. The computer program product of claim 7, wherein the processor executable program code to calculate the user fee comprises processor executable program code to calculate the user fee by multiplying said distance traveled by the applicable unit rate.

11. The computer program product of claim 7, wherein the processor executable program code to bill the consumer comprises processor executable program code to bill the consumer the user fee on an interval based on said predetermined period of time.

12. (canceled)

13. A system comprising:
a wireless network;
an onboard vehicle system for an alternative fuel vehicle that was provided to a consumer at a subsidized purchase price, wherein the onboard vehicle system is coupled to the wireless network; and
a server in communication with the onboard vehicle system via the wireless network, wherein the server is configured to:
receive mileage information from the onboard vehicle system includes a distance traveled by the alternative fuel vehicle over a predetermined period of time,
calculate a user fee based on said mileage information and an applicable unit rate, wherein the applicable unit rate is based at least in part on the subsidized purchase price, and
bill the consumer the user fee.

14. The system of claim 13, wherein the subsidized purchase price comprises a subsidized lease rate.

15. The system of claim 13, wherein said mileage information is based on at least one of global positing system data and odometer information for the alternative fuel vehicle.

16. The system of claim 13, wherein the server is further configured to calculate the user fee by multiplying the distance traveled by the applicable unit rate.

17. The system of claim 13, wherein the server is further configured to bill the consumer on an interval based on said predetermined period of time.

18. (canceled)

19. The method of claim 1, wherein the applicable unit rate is expressed as a monetary amount per unit distance.

20. The computer program product of claim 7, wherein the applicable unit rate is expressed as a monetary amount per unit distance.

21. The system of claim 13, wherein the applicable unit rate is expressed as a monetary amount per unit distance.

22. The method of claim 1, wherein the applicable unit rate is part of the customer's vehicle account information.

23. The computer program product of claim 7, wherein the applicable unit rate is part of the customer's vehicle account information.

24. The system of claim 13, wherein the applicable unit rate is part of the customer's vehicle account information.
